(19) United States
(12) Patent Application Publication
(10) Pub. No.: US 2026/0320603 A1
(43) Pub. Date: Oct. 15, 2026

(54) DEVICES, SYSTEMS, AND METHODS FOR ENABLING PERSONAL AUTHORIZATION OF FINANCIAL TRANSACTIONS

(71) Applicant: Visa International Service Association, San Francisco, CA (US)

(72) Inventor: Ganesh Joshi, Round Rock, TX (US)

(73) Assignee: Visa International Service Association, San Francisco, CA (US)

(21) Appl. No.: 19/119,130

(22) PCT Filed: Oct. 13, 2022
(86) PCT No.: PCT/US2022/078001

§ 371 Date: Apr. 8, 2025

(51) Int. Cl. G06Q 20/40

(52) U.S. Cl. CPC G06Q 20/4014; G06Q 20/405

(57) ABSTRACT

A computer-implemented method of dispositioning a transaction associated with a payment account is disclosed herein. The method can include receiving a registration request for a computing device to host transactions associated with the payment account, generating a unique identifier for the computing device, correlating the payment account to the generated unique identifier for the computing device, receiving a transaction authorization request associated with the payment account, and routing the received transaction authorization request associated with the payment account to the computing device for dispositioning based on the correlation. The computing device can host funds associated with the payment account and wherein computing device can be configured to disposition the transaction authorization request in accordance with a predetermined rule.

### TECHNICAL FIELD

The present disclosure is generally related to payment systems and, more particularly, is directed to the authorization of transaction requests via a personal computing device of a user.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a computer-implemented method of dispositioning a transaction associated with a payment account is disclosed. The method can include receiving, via an interface system, a registration request for a computing device to host transactions associated with the payment account, generating, via the interface system, a unique identifier for the computing device, correlating, via the interface system, the payment account to the generated unique identifier for the computing device, receiving, via the interface system, a transaction authorization request associated with the payment account, and routing, via the interface system, the received transaction authorization request associated with the payment account to the computing device for dispositioning based on the correlation, wherein the routed transaction authorization request is configured to be dispositioned in accordance with a rule stored locally on the computing device ..

In various aspects, an interface system configured to disposition a transaction associated with a payment account is disclosed. The system can include a device registration server communicably coupled to a plurality of computing devices, wherein the device registration server is configured to receive a registration request from a first computing device of the plurality of computing devices, and a routing server communicably coupled to a payment system, wherein the routing server is configured to receive a transaction authorization request from the payment system, and wherein the routing server is further configured to route the transaction authorization request to a first computing device of the plurality of computing devices, wherein the first computing device is configured to disposition the transaction authorization request in accordance with a rule that governs transactions made in association with the payment account, and wherein the rule is stored

In various aspects, a computer-implemented method of dispositioning a transaction associated with a payment account is disclosed. The method can include receiving, via an interface system, a registration request associated with the payment account, wherein the registration request includes information associated with a computing device, registering, via the interface system, the computing device to host transactions made in association with the payment account based on the registration request, receiving, via the interface system, a transaction authorization request associated with the payment account, correlating, via the interface system, the payment account to the information associated with the computing device, and routing, via the interface system, the transaction authorization request to the computing device based on the correlation, wherein the routed transaction authorization request is configured to be dispositioned in accordance with a rule stored locally on the computing device.

These and other and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference characters refer to identical or functionally similar elements throughout the separate views, together with the detailed description below, are incorporated in and form part of the specification, and serve to further illustrate aspects of concepts that include the claimed disclosure and explain various principles and advantages of those aspects.

The methods and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a block diagram of a payment system configured to enable consumer authorization of a financial transaction, in accordance with at least one non-limiting aspect of the present disclosure.

FIG. 2 illustrates a block diagram of an interface system of the system of FIG. 1, in accordance with at least one non-limiting aspect of the present disclosure.

FIG. 3 illustrates a logic flow diagram of a method of enabling consumer authorization of a financial transaction, in accordance with at least one non-limiting aspect of the present disclosure.

FIG. 4 illustrates a logic flow diagram of another method of enabling consumer authorization of a financial transaction, in accordance with at least one non-limiting aspect of the present disclosure.

FIG. 5 illustrates a block diagram of a computer apparatus, according to at least aspect of the present disclosure.

FIG. 6 illustrates a diagrammatic representation of an example system that includes a host machine within which a set of instructions to perform any one or more of the methodologies discussed herein may be executed, according to at least one aspect of the present disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims.

Before discussing specific aspects and examples, some descriptions of terms used

A “user” or “consumer” may include an individual or a user that may be associated with one or more personal accounts and/or consumer devices. The consumer may also be referred to as a cardholder, account holder, or user.

A “primary account number (PAN)” may be a variable length, (e.g. 13 to 19-digit) industry standard-compliant account number that is generated within account ranges associated with a BIN by an issuer.

An “authorization request message” may be an electronic message that is sent to a payment processing network and/or an issuer of a payment account to request authorization for a payment transaction. An authorization request message according to some aspects may comply with certain standards, such as International Organization for Standardization (ISO) 8583 and/or ISO 20022 acquirer to issuer card messages (ATICA), which can govern systems that exchange electronic transaction information associated with a payment made by a consumer using a payment device or a payment account. An ISO 8583 message includes a message type indicator, one or more bitmaps indicating which data elements are present in the message, and data elements of the message. The authorization request message may include an issuer account identifier that may be associated with a payment device or payment account. An authorization request message may be generated by an acceptance device or a server and may be sent to an issuing financial institution directly or through a payment network. In some aspects of the present disclosure, an authorization request message may include a payment token, an expiration date, a token presentment mode, a token requestor identifier, a token cryptogram, a token assurance level, and data used to generate the token assurance level. The payment token may include a payment token issuer identifier that may be a substitute for a real issuer identifier for an issuer. For example, the real issuer identifier may be part of a BIN range associated with the issuer. An authorization request message may also include additional data elements corresponding to “identification information” including, for example, a service code, a CVV or CVC (card verification value or code), a dCVV or dCVC (dynamic card verification value or code), token cryptogram, an expiration date, etc. An authorization request message may also include “transaction information,” such as any information associated with a current transaction (e.g. the transaction amount, merchant identifier, merchant location, etc.) as well as any other information that may be utilized in determining whether to identify and/or authorize a payment transaction. An “authorization request message” may be a message that includes a payment account identifier. The payment account identifier may be a portable consumer device account identifier associated with a portable consumer device. The authorization request message may request that an issuer of the portable consumer device authorize a transaction. The authorization request message may include an approval code indicating approval of an authorization request. The authorization request message may have a defined format to allow requests and responses between points in a financial network. The data included in the authorization request message may include data obtained from a payment device as well as other data related to the transaction, the payment account holder, the merchant, and processing information, such as one or more of a payment account number, a payment device expiration date, a currency code, a transaction amount, a merchant transaction stamp, the acceptor city, the acceptor state/country, a routing transit number, a terminal identification, a network identification, etc. An authorization request message may be protected using a secure encryption method (e.g., 128-bit SSL or equivalent) in order to prevent data from being compromised.

An “authorization response message” may be an electronic message reply to an authorization request message generated by an issuing financial institution (e.g., issuer) or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may include an authorization code, which may be a code that an account issuing bank returns in response to an authorization request message in an electronic message (either directly or through the payment processing network) to the merchant's access device (e.g. POS terminal) that indicates approval of the transaction. The code may serve as proof of authorization. As noted above, in some aspects, a payment processing network may generate and/or forward the authorization response message to the merchant.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may include one or more computational apparatuses and may use any of a variety of computing structures, arrangements, and compilations for servicing the requests from one or more client computers. In some aspects, the server computer may provide and/or support

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or′ more software applications associated with the issuer. In some non-limiting aspects, an issuer system may include one or more servers (e.g., one or more authorization servers) for authorizing a payment transaction.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

A “user device” is an electronic device that may be transported and/or operated by a user. A user device may provide remote communication capabilities to a network. The user device may be configured to transmit and receive data or communications to and from other devices. In some aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” and/or “payment application” may be used interchangeable and can include a software module with similar functionality to a payment application that has multiple accounts provisioned or enrolled such that they are usable through the wallet application. An “application” may be computer code or other data stored on a computer readable medium (e.g. memory element or secure element) that may be executable by a processor to complete a task.

“Authentication” is a process by which the credential of an endpoint (including but not limited to applications, people, devices, process, and systems) can be verified to ensure that the endpoint is who they are declared to be.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting aspects, a message may refer to a packet (e.g., a data packet, a network packet, and/or the like) that includes data. It will be appreciated that numerous other arrangements are possible.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer, a minicomputer, a mainframe, a server, a server farm, etc. Furthermore, the term “computer” may refer to any computing device that includes the necessary components to send, receive, process, and/or output data, and normally includes a display device, a processor, a memory, an input device, a network interface, and/or the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function. As described herein, computational functions and methods performed by computing devices can, according to other non-limiting aspects, be performed by servers and vice versa.

As used herein, the term “system” may refer to one or more computing devices or combinations of computing devices (e.g., processors, servers, client devices, software applications, components of such, and/or the like).

As used herein, a “mobile device” may include any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may include any suitable hardware and software for performing such functions, and may also include multiple devices or components (e.g. when a device has remote access to a network by tethering to another device—e.g., using the other device as a modem—both devices taken together may be considered a single mobile device).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes, payment account details and other login information, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CW2 (card verification value 2), CVC3 card verification values, etc. CW2 is generally understood to be a static verification value associated with a payment device. CW2 values are generally visible to a user (e.g., a consumer), whereas CW and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an aspect of the present disclosure, but other elements may be added and still form a construct within the scope of a claim. In contrast, the transitional phrase “consisting of” excludes any element, step, or ingredient not specified in a claim. This is consistent with the use of the term throughout the specification.

As used herein, an “electronic wallet” or “digital wallet” or “mobile wallet” can store user profile information, payment information (including tokens), bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. An “electronic wallet mobile application,” and “digital wallet” may refer to one or more electronic devices and/or one or more software applications configured to store, display, or process a credential or payment credentials.

The term “transaction data” may include any data associated with one or more transactions. In some aspects, the transaction data may merely include an account identifier (e.g., a PAN) or payment token. Alternatively, in other aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

A “user” may include an individual. In some aspects, a user may be associated with one or more personal accounts and/or mobile devices. The user may also be referred to as a cardholder, account holder, or consumer.

An “acquirer” may refer to an entity licensed by the transaction service provider and/or approved by the transaction service provider to originate transactions (e.g., payment transactions). Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” may typically be a business entity (e.g., a commercial bank) that has a business relationship with a particular merchant or other entity. Some entities can perform both issuer and acquirer functions. Some aspects may encompass such single entity issuer-acquirers. An acquirer may operate an acquirer computer, which can also be generically referred to as a “transport computer”.

As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting aspects, an acquirer may be a financial institution, such as a bank.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (“DSP”), programmable logic device (“PLD”), programmable logic array (“PLA”), or field programmable gate array (“FPGA”), state machine circuitry, firmware that stores instructions executed by programmable circuitry, and any combination thereof). The control circuit may, collectively or individually, be embodied as circuitry that forms part of a larger system, for example, an integrated circuit (“IC”), an application-specific integrated circuit (“ASIC”), a system on-chip (“SoC”), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof. Additionally, it shall be appreciated that, as referenced herein, any specific type of control circuit can be effectively interchanged with any of the control circuits described above.

Before explaining various aspects of the present disclosure in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

Consumers have historically utilized cash to purchase goods and services without restriction. Since the consumer is in exclusive possession of the cash, they possess the authority to host a transaction in their exclusive discretion. For example, if a consumer decides to purchase goods or services with cash, they can do so without seeking the approval or authorization of a third party. However, modern payment systems can process transactions made via a number of alternate payment methods that many consumers might find more secure or convenient than cash. Indeed, payment cards (e.g., debit cards, credit cards, gift cards, prepaid cards, etc.) facilitate the access and utilization of account balances that are higher than an amount of cash that a consumer would otherwise be comfortable carrying in cash.

Prepaid cards (e.g., reloadable gift cards, preauthorized debit cards, etc.), for example, have emerged as a convenient method for consumers to fund transactions. For example, prepaid cards can be configured to access and/or store a prepaid balance of funds. Any purchases using the prepaid card can be deducted from the balance. Whereas a consumer must have a bank account associated with a regular debit card, prepaid cards can function independent of an account hosted by an issuer, such as a bank or any other third-party institution. Some prepaid cards, for example, can use a counter to keep track of how much has been spent until the funds on the card reach zero, or all the money has been spent. As used herein, a “counter” is a record of the amount of money spent using the prepaid card. Thus, funds—or more precisely, data representing the funds—stored on a prepaid card can be used to establish more autonomy from issuers, such as financial institutions or any other third-party entities. In other words, compared to credit cards or debit cards, prepaid cards can reduce consumer third-party dependency, promoting consumer autonomy, transaction efficiency, and—in some cases—reduced fees.

However, even prepaid cards are not completely exempt from third-party intervention. Indeed, prepaid cards are still issued by third-party entities, even though they are not connected to a line of credit or regular checking account. Although a consumer may have access to the money loaded onto a prepaid card and isn't transacting via money in an account or borrowed money, the issuing third-party entity still authorizes or “hosts” transactions made via the prepaid card. When a consumer pays for goods and services with cash, they can use it freely, according to their discretion, without having to rely upon third-party authorization or control. However, the opposite is true for payments processed using conventional payment systems, including those processed via prepaid cards. The consumer, therefore, does not wield ultimate control over their own assets, as issuing entities still gate the processing of transactions via centralized approval processes. In other words, conventional payment systems empower issuing entities as hosts in lieu of the consumer—the true owner of the assets stored on a prepaid card. Accordingly, there is a need for improved devices, systems, and methods for enabling consumer authorization of financial transactions.

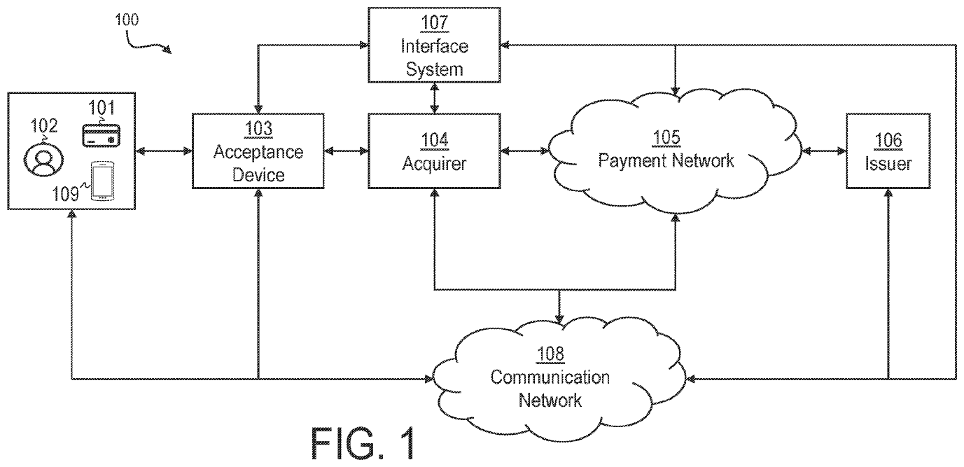

Referring now to FIG. 1, a block diagram of a payment system 100 configured to enable consumer authorization of a financial transaction is depicted in accordance with at least one non-limiting aspect of the present disclosure. According to the non-limiting aspect of FIG. 1, the system 100 can include an acceptance device 103, an acquirer 104, a payment network 105, and an issuer 106, all of which may be servers operated by one or more entities. It shall be appreciated by a person of skill in the art that there are many possible configurations for the systems configured to achieve a similar result as the system 100 of FIG. 1 and thus, the present disclosure contemplates other systems that include fewer or more entities, each of which may perform some or all of the tasks of the others, and may be owned or operated by various entities, including merchants, payment networks, and financial institutions. As such, the system 100 of FIG. 1 is merely illustrative. Likewise, communications between various components of the system 100 of FIG. 1 are shown as bi-directional, meaning information can be exchanged to and from each component.

According to the non-limiting aspect of FIG. 1, the system 100 can enable a user 102 to perform a transaction associated with a payment account via an acceptance device 103, which can be owned and/or operated by a merchant. For example, according to the non-limiting aspect of FIG. 1, the payment account can be associated with a prepaid payment card 101 of the user 102. However, according to other non-limiting aspects, the payment account can be associated with any other payment asset and/or device, including a debit or credit card, and/or a digital asset, such as a token. Accordingly, it shall be appreciated that references to the prepaid payment card 101, as used herein, are merely illustrative. The devices, systems and methods disclosed herein can be implemented via any payment account associated with any payment asset or device.

For example, the user 102 of FIG. 1 can further utilize a computing device 109, which may include a smartphone, portable computer, a personal computer, smart-watch or other wearable, and/or any other device configured to access account information (e.g., payment accounts, etc.) and/or manage a transaction associated with unique identifiers of the prepaid payment card 101. However, according to other non-limiting aspects, the computing device 109 can be used in lieu of or as a digital proxy for the prepaid payment card 101. For example, according to such aspects, the user 102 may possess a physical prepaid payment card 101 but register the prepaid payment card 101 for digital use via an electronic wallet hosted by one or more computing devices 109. As such, the computing device 109 can be configured to transmit a unique identifier associated with a payment account or prepaid payment card 101 to the acceptance device 103 to initiate a transaction.

As depicted in FIG. 1, any of the components of the system 100 of FIG. 1 can be communicably coupled for direct and/or indirect communication with one another via a communication network 108. According to some non-limiting aspects, the communication network 108 can include an infrastructure network, such as the internet via a local area network or wireless local area network, or a cellular network. However, according to other non-limiting aspects, the communication network 108 can include an ad hoc network, such as a Bluetooth® connection, a near-field communication (“NFC”) network, and/or radio frequency identification (“RFID”) technology. According to other non-limiting aspects, the communication network 108 can include a combination of infrastructure and/or ad hoc networks. For example, the computing device 109 can be communicably coupled to the acceptance device 103 via Bluetooth® or NFC and the acceptance device 103, acquirer 104, payment network 105, interface system 107, and/or issuer 106 can be communicably coupled via the internet.

In further reference to FIG. 1, according to some non-limiting aspects, a user 102 can initiate a transaction via the prepaid payment card 101 by transmitting unique identifiers associated with the prepaid payment card 101 to the acceptance device 103. For example, the acceptance device 103 can include a physical and/or wireless receiver configured to receive the unique identifiers associated with the prepaid payment card 101 and the user 102 may swipe a magnetic strip of the prepaid payment card 101, insert a chip of the prepaid payment card 101, or wirelessly transmit unique identifiers associated with the prepaid payment card 101 via the receiver of the acceptance device 103. Regardless, the acceptance device 103 can be configured to interact with (e.g., scan, interrogate, read, etc.) the computing device 109 and/or a payment card 101. As previously discussed, according to the non-limiting aspect, wherein the computing device 109 is used as a digital proxy for the prepaid payment card 101, the computing device 109 can transmit unique identifiers associated with the prepaid payment card 101 to the acceptance device 103.

Still referring to the non-limiting aspect of FIG. 1, when the user 102 initiates a transaction via the unique identifiers associated with the prepaid payment card 101, the acceptance device 103 can generate a transaction authorization request and transmit the transaction authorization request to a server operated by an acquirer 104. According to the non-limiting aspect of FIG. 1, the acquirer 104 can include a financial institution at which a merchant operating the acceptance device 103 maintains an account. The acquirer 104 can route the transaction authorization request message to a payment network 105—which may include one or more databases and one or more servers configured to forward the transaction authorization request message for assessment and/or approval—depending on the unique identifiers and/or data corresponding to a merchant or acceptance device 103.

According to other systems, the payment network 105 may forward the transaction authorization request message to a server operated by an issuer 106 associated with a unique identifier and/or payment card utilized in a transaction. Conventionally, the issuer 106 can host one or more accounts owned by user 102. The issuer 106 may approve or decline the transaction authorization request depending on an account balance, payment history, or spending trends associated with the user 102, for example. Even payment devices that promote an increased autonomy of the user 102, such as the prepaid payment card 101, are typically issued by banks and/or financial service companies—even if such payment devices are not issued on or associated a line of credit or a bank account of the user 102. Thus, other systems would still route a transaction authorization request associated with the prepaid payment card 101 to the issuer 106 for review and approval. Upon approving or declining the transaction, the issuer 106 can generate an authorization response message, which may, in some non-limiting aspects, be formatted according to the ISO 8583 and/or the ISO 20022 ATICA messaging standards. The issuer 106 can transmit the authorization response message to payment network 105, which can in turn inform the acquirer 104 and/or acceptance device 103 that the transaction authorization request has been approved.

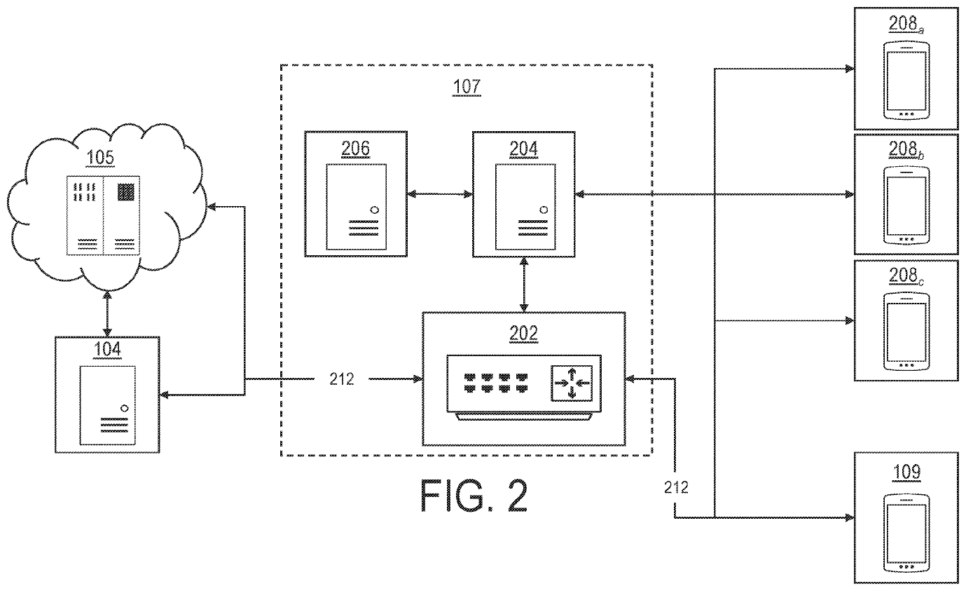

However, according to the non-limiting aspect of FIG. 1, the system 100 can further include an interface system 107 configured to receive and disposition transaction authorization requests associated with the prepaid payment card 101. For example, as will be described in more detail with reference to FIG. 2, the interface system 107 can be configured to manage the transaction authorization request associated with the prepaid payment card 101 in accordance with one or more rules predetermined by the user 102. According to one non-limiting aspect, the one or more rules may be stored locally on the computing device or remotely stored on a server of the interface system 107. Moreover, the interface system 107 can be configured to route transaction authorization requests associated with the prepaid payment card 101 to one of a plurality of computing devices 208_{a-c} (FIG. 2)—including the computing device 109 of the user 102—which the user 102 can register to host transactions associated with the prepaid payment card 101. As used herein, the term “host” includes the ability to approve, authenticate, authorize, and/or otherwise manage transactions associated with the prepaid payment card 101, unless otherwise regulated or restricted. Because the user 102—or an individual delegated by the user 102—maintains agency over the designated computing device 109, the user 102—or the individual delegated by the user 102—can approve the transaction in lieu of the issuer 106, as is the case in other systems. Thus, via the interface system 107, the system 100 of FIG. 1 can enable consumer authorization of a financial transaction in ways prior systems could not.

Still referring to FIG. 1, the payment network 105 can be configured to communicate with the interface system 107 via the communications network 108 for proper routing and/or approval of the transaction authorization request via the designated computing device 208_{a-c} (FIG. 2). For example, according to some non-limiting aspects, the user 102 may install an application on the computing device 109, wherein the application can receive inputs from the user 102 including information, rules, and/or instructions pertaining to the routing and approval of transaction authorization requests associated with the prepaid payment card 101. Alternately and/or additionally, communications between the interface system 107 and other system 100 components can be facilitated via an application programming interface (“API”) configured to enable communication between various applications deployed by the various components of the system 100, such as the computing device 109, the acceptance device 103, the acquirer 104, the issuer 106, and/or the interface system 107. For example, the API can be stored in a memory of a server of the payment network 105 and, along with instructions also stored in the memory, can cause the one or more servers of the payment network 105 to perform the methods disclosed herein. Regardless, an application and/or API can be accessed by a user 102 via the computing device 109 and can receive inputs from the user 102 including information, rules, and/or instructions pertaining to the routing and approval of transaction authorization requests associated with the prepaid payment card 101. As such, the user 102 can utilize the application and/or API to designate one of the plurality of computing devices 208_{a-c} (FIG. 2) to approve transactions associated with the prepaid payment card 101 and/or program specific rules by which transactions associated with the prepaid payment card 101 may or may not be approved.

For example, according to some non-limiting aspects, the application can be stored on a local memory of the computing device 109 and executed via a processor of the computing device 109. According to other non-limiting aspects, the application can be hosted on a remote server communicably coupled to the computing device 109, accessed via a web-browser of the computing device 109, and configured to receive user inputs from the computing device 109. Regardless, either the application itself or an API integrated into the application can be utilized to establish rules pertaining to how transactions associated with the unique identifiers of a prepaid payment card 101 are processed. For example, the user 102 can utilize the application, executed by or otherwise accessed via the computing device 109, to generate an API call that includes instructions and/or rules as to how transactions associated with the unique identifier of the prepaid payment card 101 should be processed. Based on those instructions and/or rules, the interface system 107 can ensure that the transaction request is routed to a designated computing device 208_{a-c} (FIG. 2) for approval in lieu of the issuer 106. Additionally, the interface system 107 can ensure that only a designated computing device 208_{a-c} (FIG. 2) can only approve transactions in accordance with rules established by the user 102, as will be discussed in further detail herein.

In summary, the system 100—and more specifically, the interface system 107—of FIG. 1 can be utilized to enable consumer authorization of a financial transaction associated with the prepaid payment card 101. Once the user 102 accesses the application and/or an integrated API, they may register a computing device 109, order a prepaid payment card 101, manage a balance on a prepaid payment card 101, and/or securely map a unique identifier associated with the prepaid payment card 101 to a designated computing device computing device 109. For example, according to the non-limiting aspect wherein the computing device 109 includes a smart phone, the user 102 may securely map a unique identifier associated with the prepaid payment card 101 to the designated computing device 109 via computing device 109 identifying information. Regardless, the interface system 107 literally interfaces the payment network 107 and a designated computing device 109 of the user 102, and governs how transactions associated with a unique identifier of the prepaid payment card 101 are processed.

Referring now to FIG. 2, a block diagram of the interface system 107 of the system 100 of FIG. 1 is depicted in accordance with at least one non-limiting aspect of the present disclosure. According to the non-limiting aspect of FIG. 2, the interface system 107 can include an routing server 202, a device registration server 204, and a prepaid card management server 206 configured to communicate with a plurality of computing devices 208_{a-c}, including the computing device 109 of the user 102, as depicted in FIG. 1. The routing server 202 of the interface system 107 can be configured to communicate with the payment network 105, and the acquire system 104 of the payment system 100 of FIG. 1. However, it shall be appreciated that, according to some non-limiting aspects, the interface system 107 of FIG. 2 can be a subsystem of the payment network 105. According to the non-limiting aspect of FIG. 2, each of the plurality of computing devices 208_{a-c} are depicted as mobile devices, such as smartphones. However, it shall be appreciated that, according to other non-limiting aspects, the plurality of computing devices 208_{a-c} can include any client device, including a desktop computer, a laptop computer, a mobile computer (e.g., a tablet), a wearable computer (e.g., a watch, a pair of glasses, a lens, clothing, and/or the like), or a network-enabled appliance capable of hosting software configured to communicate with a components of the interface system 107 and/or payment system 100 (FIG. 1).

According to the non-limiting aspect of FIG. 2, the device registration server 204 can be configured to register a plurality of computing devices 208_{a-c}, including the computing device 109 of the user 102, as depicted in FIG. 1. Once registered, the computing devices 208_{a-c}, 109 can be configured for use via the interface system 107 of FIGS. 1 and 2. The registration can include a predetermined set of rules for transactions made in association with the unique identifier of the prepaid payment card 101 (FIG. 1). The predetermined set of rules can include, for example, the designation of a computing device, such as the computing device 109 of the user 102, as depicted in FIG. 1, as host of transactions made in association with the unique identifier of the prepaid payment card 101 (FIG. 1). However, according to other non-limiting aspects, the predetermined set of rules can include other restrictions, permissions, and/or management of transactions made in association with the prepaid payment card 101 (FIG. 1), as will be discussed in further detail herein. Notably, by registering the computing device 109 of the user 102 (FIG. 1) as the host of transactions associated with the unique identifier of the prepaid payment card 101 (FIG. 1), the interface system 107 of FIG. 2 can enable the user 102 (FIG. 1) to authorize financial transactions in lieu of an issuer 106 (FIG. 1).

In further reference to the non-limiting aspect of FIG. 2, the device registration server 204 and/or prepaid card management server 206 can be communicably coupled to the routing server 202. Thus, the device registration server 204 and/or prepaid card management server 206 can communicate information associated with one or more predetermined rules to the routing server 202, including an information associated with a computing device 109 designated as host of a transaction and/or a unique identifier associated with a prepaid payment card 101 (FIG. 1) used during the transaction. The routing server 202, moreover, can be communicably coupled to the payment network 105 and/or acquirer 104, or any other components of the payment system 100 of FIG. 1. According to some non-limiting aspects, the routing server 202 can be specifically configured for a particular type of standardized and/or secure communications with other components of the payment system 100 (FIG. 1). For example, according to some non-limiting aspects, the routing server 202 can communicate with the payment system 100 via international organization standard (ISO) 8583 verified channels 212.

According to one non-limiting aspect, a user 102 (FIG. 1) can utilize the interface system 107 of FIG. 2 to register the user's computing device 109 (FIG. 1) and designate it as host of transactions made with the prepaid payment card 101 (FIG. 1). The device registration server 204 of the interface system 107 receive registration requests from a plurality of computing devices 208_{a-c}, including the computing device 109 of the user 102 (FIG. 1). Thus, the user 102 (FIG. 1) can initiate a registration request to the device registration server 204 by accessing an application and/or an integrated API. In some non-limiting aspects, the application may be accessed via the computing device 109, itself. Via a graphical user interface of the application and/or API, the user 102 (FIG. 1) can generate a registration request by entering information associated with the computing device 109 and information associated with the prepaid payment card 101 (FIG. 1), whose transactions the user 102 (FIG. 1) wants the computing device 109 to manage as host. For example, information associated with the computing device 109 (or computing device 109 identifying information) can include an IMEI, a phone number, a subscriber identity module (“SIM”), a MAC address, a mobile identification number (MIN), a mobile subscription identification number (MSIN), and/or any other information that is specifically and exclusively associated with the computing device 109. Information associated with the prepaid payment card 101 (FIG. 1) can include, for example, a unique identifier or any other suitable information associated with the prepaid payment card 101 (FIG. 1), including a PAN, a user name, an expiration date, and/or a CVV, amongst other forms of account information.

Once the registration request has been generated, the application and/or integrated API can transmit the registration request to the device registration server 204 of the interface system 107 of FIG. 2, including the information associated with the computing device 109 (FIG. 1) the user 102 (FIG. 1) wants to register as host of transactions. According to one non-limiting aspect, the registration request can further include funding and/or an instruction to fund an account the user 102 (FIG. 1) wants to host transactions with via the computing device 109 (FIG. 1). Once the account is funded, the interface system 107 can generate a new payment account, which—as previously described—can include a new prepaid payment card and/or digital token. For example, a digital token can be used as an alias for a payment account and/or otherwise associated with a PAN. According to other non-limiting aspects, the user 102 (FIG. 1) may register or reload an existing prepaid payment card and/or digital token for use via the interface system 107. As such, the application or integrated API can transmit the registration request to the device registration server 204 of the interface system 107 of FIG. 2, including the information associated with the computing device 109. According to some non-limiting aspects, the registration request can include a request for a new payment account to be generated by the interface system 107. However, according to other non-limiting aspects, the registration request can include information associated with a pre-existing payment account. According to both non-limiting aspects, the interface system 107 can be implemented such that the computing device 109 can host transactions associated with the payment account.

Upon receiving the registration request, the device registration server 204 can register the computing device 109 and designate it to host transactions made in association with the prepaid payment card 101 (FIG. 1). Successful registration can include, for example, correlating the payment account—whether newly generated by the interface 107 or preexisting—to a unique identifier associated with the device, such as a phone number and/or an international mobile equipment identity (IMEI) number. The correlation can be stored by the interface system 107, as will be described in further detail herein, for dispositioning transaction requests to registered computing device 109 (FIG. 1) associated with the payment account.

For example, the device registration server 204 can correlate the information associated with the computing device 109 to the information associated with the prepaid payment card 101 (FIG. 1). The correlated information that was included in the registration request—including the information associated with the computing device 109 and information associated with the prepaid payment card 101 (FIG. 1)—can be stored in the prepaid card management server 206 of the interface system 107 for future reference by the interface system 107.

Additionally and/or alternatively, the predetermined set of rules can include other user 102 (FIG. 1) generated rules, including various restrictions and/or permissions to govern the management of transactions made in association with the prepaid payment card 101 (FIG. 1). For example, according to some non-limiting aspects, the user 102 (FIG. 1) may decide to restrict the type of transactions a prepaid payment card 101 (FIG. 1) can be used for. The user may establish the predetermined rules via the computing device 109. For example, similar to the generation of a device registration request, the user 102 (FIG. 1) can enter information associated with each rule via a graphical user interface of the application and/or an integrated API accessed via the computing device 109. According to one non-limiting aspect, the predetermined rules can be stored locally on the computing device 109 and accessed by the computing device to disposition a particular transaction request. However, according to other non-limiting aspects, such rules can be received by the device registration server 204, which can correlate the rules to information associated with the desired unique identifier of the prepaid payment card 101 (FIG. 1) and store the correlation in the prepaid card management server 206 for future reference by the interface system 107.

The predetermined set of rules, therefore, may cause the interface system 107 to automatically decline undesired transactions (e.g., gambling transactions, purchases of alcohol or pharmaceuticals, etc.) made with the prepaid payment card 101 (FIG. 1). The automatic declination of undesired transaction can be based on a particular transaction code generated by the acceptance device 103 (FIG. 1). A transaction code can be any code, for example, such as a merchant category code (MCC), used to classify purchases. As such, a transaction code may classify a transaction initiated by the user 101 via the payment account as a grocery purchase, a restaurant purchase, a purchase associated with a particular form of entertainment, etc. Alternately and/or additionally, the predetermined set of rules may cause the interface system 107 to automatically decline transactions made with the prepaid payment card 101 (FIG. 1) at a particular time of day (e.g., during school hours, late at night, etc.). According to still other non-limiting aspects, one or more rules can be based on a particular asset class. For example, a prepaid payment card 101 (FIG. 1) can be associated with multiple accounts involving different assets (e.g., United States Dollar (USD), United Kingdom Pound, a cryptocurrency, etc.), all of which can be hosted on the computing device 109. The acceptance device 103 may provide the user 102 (FIG. 1) with an option as to which asset should be used for a particular transaction. For example, the user 102 (FIG. 1) may choose to pay for a particular transaction using a cryptocurrency-based account, which can be hosted on the same computing device 109 as a USD-based account, or a separate computing device. Accordingly, the rule may cause the interface system 107 to route the transaction authorization request to the appropriate computing device that hosts the account associated with the asset the user 102 (FIG. 1) has selected for payment.

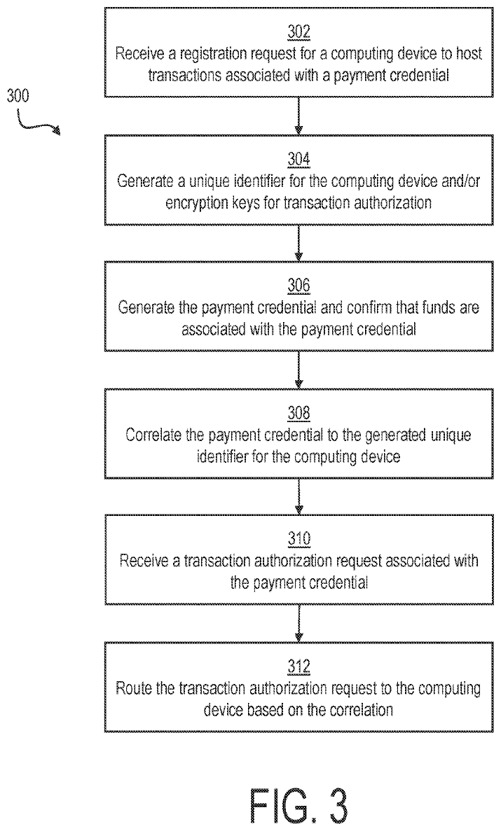

Accordingly, when the interface system 107 of FIG. 2 receives a transaction authorization request associated with the prepaid payment card 101 (FIG. 1), the interface system 107 can search the prepaid card management server 206 for any rules that have been correlated with the unique identifier or any other account information associated with the payment card 101 (FIG. 1). Alternately, according to non-limiting aspects wherein the rules are locally stored on the computing device 109, the computing device can search its memory for relevant rules. It shall be appreciated that the transaction authorization request can be initiated via the physical prepaid payment card 101 (FIG. 1) or via an electronic wallet configured to transmit a unique identifier associated with the prepaid payment card 101 to the acceptance device 103. Regardless, assuming one or more predetermined rules have been stored in the prepaid card management server 206 in correlation with the payment card 101 (FIG. 1), the interface system 107 can disposition the transaction authorization request in accordance with the predetermined set of rules. For example, if the user 102 (FIG. 1) has established a rule designating the computing device 109 as host of transactions associated with the payment card 101 (FIG. 1), the routing server 202 of the interface system 107 can detect the designated computing device 109 amongst the plurality of computing devices 208_{a-c} and route the transaction authorization request to the designated computing device 109 for review and approval by the user 102 (FIG. 1), or any other individual that maintains agency over the designated computing device 109. The transaction authorization request, for example, can be displayed via a graphical user interface of an application and/or integrated API accessed by the computing device 109. The user 102 (FIG. 1) can, according to some non-limiting aspects, provide a user input (e.g., engage with a widget of the user interface, provide an audible command, provide an identity verifying biometric, etc.) indicating the user's 102 (FIG. 1) approval of the transaction authorization request. As such, the computing device 109 can transmit a signal indicating the user's 102 (FIG. 1) approval of the transaction authorization request to the payment network 105, acquirer 104, or any other component of the payment system 100 of FIG. 1 to settle the transaction, as will be explained in further detail herein with reference to the method 300 of FIG. 3.

As such, the interface system 107 of FIG. 2 can provide the payment system 100 of FIG. 1 with many benefits. For example, a user 102 (FIG. 1) may designate their own computing device 109 as host of transactions made in association with their own prepaid payment card 101 (FIG. 1). This can enhance the user's 102 (FIG. 1) insight and control regarding the use of their prepaid payment card 101 (FIG. 1). If the user 102 (FIG. 1) receives a transaction authorization request via their computing device 109 indicating that the prepaid payment card 101 (FIG. 1) is being used in association with an anomalous or unrecognized transaction, the user 102 (FIG. 1) may decide to decline the transaction authorization request. Unlike conventional systems, the interface system 107 enables this benefit by imbuing the user 102 (FIG. 1)—and more specifically, the computing device 109—with the exclusive authority to approve or decline transactions associated with the payment account, or prepaid payment card 101 (FIG. 1), instead of the issuer 106 (FIG. 1).

According to other non-limiting aspects, the user 102 (FIG. 1) may seek oversight and/or control of a third party's transactions via the prepaid payment card 101 (FIG. 1). For example, the user 102 (FIG. 1) may be a parent seeking to restrict a child's spending via the prepaid payment card 101 (FIG. 1). As such, the parent 102 (FIG. 1) may designate their own computing device 109 (FIG. 1) as host of transactions associated with the child's prepaid payment card 101 (FIG. 1). According to such non-limiting aspects, other predetermined rules may further assist the parent 102 (FIG. 1) in restricting the child's spending via the prepaid payment card 101 (FIG. 1). For example, the parent 102 (FIG. 1) may register one or more rules configured to cause the interface system 107 to automatically decline undesired transactions (e.g., gambling transactions, purchases of alcohol or pharmaceuticals, etc.) or transactions made at a particular time of day (e.g., during school hours, late at night, etc.). According to still other non-limiting aspects, a user 102 (FIG. 1) may designate two or more computing devices of the plurality of computing devices 208_{a-c} to host of transactions made in association with the prepaid payment card 101 (FIG. 1). In other words, by supplanting the issuer 106 with the user 102 (FIG. 1) as host and enabling the customization of predetermined rules that govern transactions made in association with the prepaid payment card 101 (FIG. 1), the interface system 107 of FIG. 2 can promote efficiency, increase security, and enhance user 102 (FIG. 1) autonomy within the payment system 100 of FIG. 1.

Referring now to FIG. 3, a logic flow diagram of a method 300 of enabling consumer authorization of a financial transaction is depicted in accordance with at least one non-limiting aspect of the present disclosure. For example, according to some non-limiting aspects, the method 300 can be implemented by the interface system 107 of FIG. 2, or various components thereof. According to the non-limiting aspect of FIG. 3, the method 300 can include receiving 302 a registration request for a computing device 109 (FIG. 1) to host transactions associated with a payment account. Upon receiving the registration request, the method 300 can further include generating 304 a unique identifier for the computing device 109 (FIG. 1) by which the computing device 109 (FIG. 1) can be identified by the interface system 107 (FIG. 2). According to some non-limiting aspects, the method 300 can further include generating encryption keys which would be necessary for the computing device 109 (FIG. 1) to authorize transactions authorization requests associated with the payment account.

In further reference to FIG. 3, the method 300 can be implemented to enable consumer authorization of financial transactions made in association with either a new or existing payment account. As such, the method 300 can further include generating 306 a new payment account itself. However, according to other non-limiting aspects, information associated with an existing payment account can be provided via the registration request, as the registration request can include a request for a computing device 109 (FIG. 1) to host transactions associated with the existing payment account. Regardless, the method 300 can further include confirming that funds have been associated with the payment account. According to the non-limiting aspect wherein the method 300 includes generating 306 a new payment account, this can include confirming that the registration requests included an initial funding of the payment account, or issuing a request to the computing device 109 (FIG. 1) prompting the consumer to provide funds. According to the non-limiting aspect wherein the method 300 includes utilizing an existing payment account, the method 300 can include confirming that funds have been previously provided in association with the existing payment account.

The method 300 of FIG. 3 can further include correlating 308 the payment account to the generated unique identifier associated with the computing device 109 (FIG. 1). Once the unique identifier associated with the computing device 109 (FIG. 1) is correlated to the payment account, the method 300 can include receiving 310 a transaction authorization request associated with the payment account. For example, as previously described, the transaction authorization request can come from an acquirer 104 (FIG. 1) that initiated the transaction at the consumer, or user's 102 (FIG. 1), request. The method 300 can include routing 312 the received transaction authorization request to the computing device 109 (FIG. 1) based on the correlation. The consumer, via the computing device, can then approve or decline the transaction in a similar manner to how issuers 106 (FIG. 1) approve or decline transactions in conventional systems.

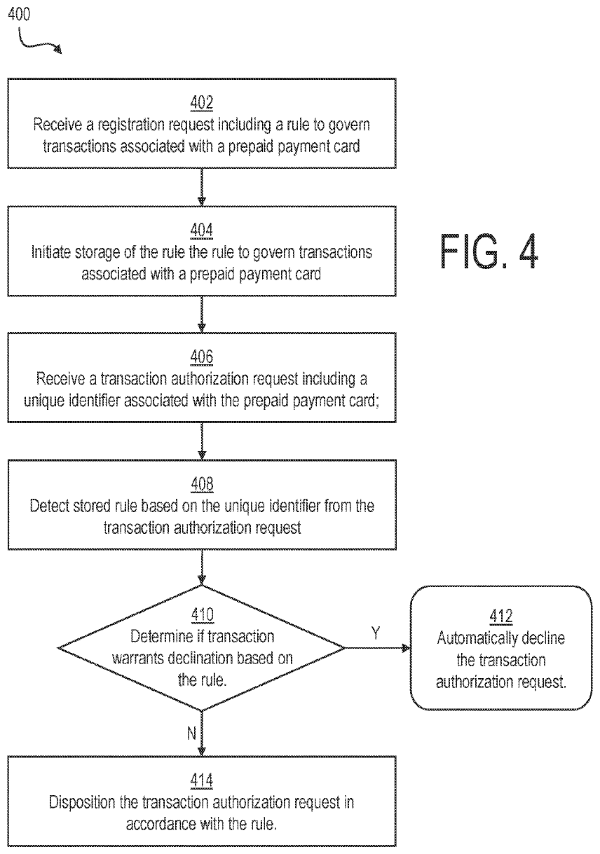

Referring now to FIG. 4, a logic flow diagram of another method 400 of enabling consumer authorization of a financial transaction is depicted in accordance with at least one non-limiting aspect of the present disclosure. For example, according to some non-limiting aspects, the method 400 can be implemented by the interface system 107 of FIG. 2, or various components thereof. According to the non-limiting aspect of FIG. 4, the method 400 can include receiving 402 a registration request associated with the prepaid payment card 101 (FIG. 1). For example, the registration request can include a rule by which the payment system 100 (FIG. 1)—and more specifically, the interface system 107 of FIG. 2—can govern transactions made in association with the prepaid payment card 101 (FIG. 1). For example, the registration request can include computing device 109 (FIG. 1) information (e.g., an IMEI, a phone number, a media access control (MAC) address, etc.) and/or information associated with the prepaid payment card 101 (FIG. 1) (e.g., a PAN, a user name, an expiration date, a CVV, etc.).

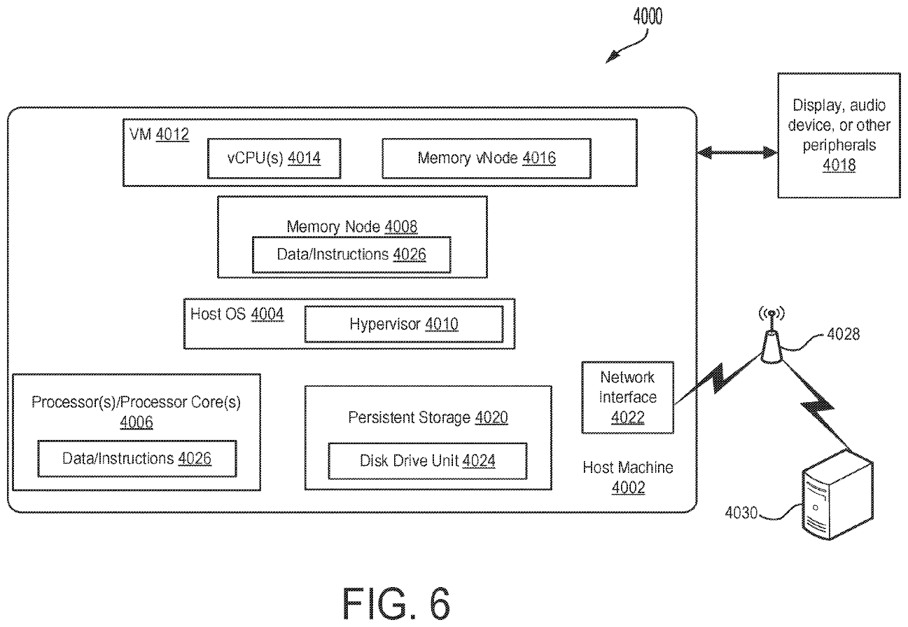

Additionally, according to the non-limiting aspect of FIG. 4, the method 400 can include storing 404 the rule. For example, the rule can be stored within a prepaid payment card management server 206 (FIG. 2) of the interface system 107 (FIG. 2) or can be stored locally on a memory of the computing device 109 (FIG. 1). The method can further include receiving 406 a transaction authorization request from the payment system 100 (FIG. 1). For example, according to some non-limiting aspects, the transaction authorization request can include a unique identifier associated with the prepaid payment card 101 (FIG. 1). As such, the method 400 can include detecting 408 the rule stored in the prepaid payment card management server 206 (FIG. 6). According to some non-limiting aspects, the detection 408 can be based on a correlation of information in the transaction authorization request with information from the registration request. For example, the detection 408 can be based on the unique identifier.

In further reference to FIG. 4, the method 400 can further include determining 310 whether the rule requires an automatic declination of the transaction authorization request. The determination 310 can be based on information within the transaction authorization request. For example, as previously discussed, the rule may preclude the prepaid payment card 101 (FIG. 1) from being used for a particular transaction type (e.g., gambling transactions, purchases of alcohol or pharmaceuticals, etc.) or at a particular time (e.g., during school hours, late at night, etc.). If the transaction authorization request includes information indicating that the prepaid payment card 101 (FIG. 1) was used for particular transaction type and/or during a particular time of day that is precluded by the rule, the method 400 can include automatically declining 312 the transaction authorization request

However, according to the non-limiting aspect of FIG. 4, assuming the transaction authorization request includes information indicating that the prepaid payment card 101 (FIG. 1) was used in compliance with the rule, the method 400 can further include dispositioning 314 the transaction authorization request in accordance with the rule. For example, if the registration request included the registration of a computing device 109 (FIGS. 1 and 2) as host of transactions made in association with the prepaid payment card 101 (FIG. 1), dispositioning 314 the transaction authorization request can include routing, via a routing server 202 (FIG. 2) of the interface system 107 (FIG. 2) the transaction authorization request to the registered computing device 109 (FIGS. 1 and 2). As such, according to some non-limiting aspects, the method 400 can further include receiving a signal associated with an approval of the transaction authorization request from the registered computing device 109 (FIGS. 1 and 2).

Still referring to FIG. 4, according to other non-limiting aspects, the method 400 can include settling the transaction authorization request. For example, the method 400 can include transmitting an instruction to transfer an asset associated with the prepaid payment card 101 (FIG. 1) to an acquirer 104 (FIGS. 1 and 2). According to some non-limiting aspects, the settlement can be achieved via a single-message settlement and not a dual-message. The single message will do settlement and clearing in one shot. For example, according to the non-limiting aspect wherein the method 400 includes a single-message settlement, the computing device 109 (FIG. 2) and/or the interface system 107 (FIG. 2) can transmit an authorization response message in response to the transaction authorization request that includes an approval and settlement data in a single message, instead of sending a separate settlement message from the issuer 106 (FIG. 1) after an approval message from the registered computing device 109 (FIG. 2). According to other non-limiting aspects, settlement can be achieved via a person-to-person (P2P) payment, which can allow the user 102 (FIG. 1) to transfer funds associated with the prepaid payment card 101 (FIG. 1) to the acquirer 104 (FIGS. 1 and 2). For example, the settlement can be performed in accordance with existing payment rails, only instead of the issuer 106 (FIG. 1), the application and/or API that serves as the interface between the payment network 105 (FIG. 1) and the computing device 109 (FIG. 1) will be responsible for matching transactions and settling the funds with the merchant. Lifecycle messages such as disputes will also be processed using existing payment rails and interfaces. Accordingly the method 400 can further include ensuring, via the interface system 107 (FIG. 2), that the prepaid payment card 101 (FIG. 1) has sufficient funds to satisfy the transaction authorization request.

According to other non-limiting aspects, the computing device 109 (FIG. 1) hosting the may be the same computing device 109 (FIG. 1) configured to host transaction associated with the payment account. As such, the computing device 109 (FIG. 1) initiating the digital token-based transaction and authorizing the digital token-based transaction will be same. Therefore, routing through the transaction authorization request through the interface system 107 (FIG. 2) can be completely skipped, which could bring down overall transaction processing time. Such non-limiting aspects can be enhanced by security features incorporated into token wallets (e.g., Apple Pay, Google Pay, etc.) such as the verification of an authorized user's biometric (e.g., FaceID, TouchID, etc.) or the a password or pass key. Thus, assuming the user can unlock the wallet and present a token to merchant, a certain degree of security underlies the transaction, further warranting the exclusion of the transaction authorization request being routed through the interface system 107 (FIG. 2) and the promotion of efficiency.

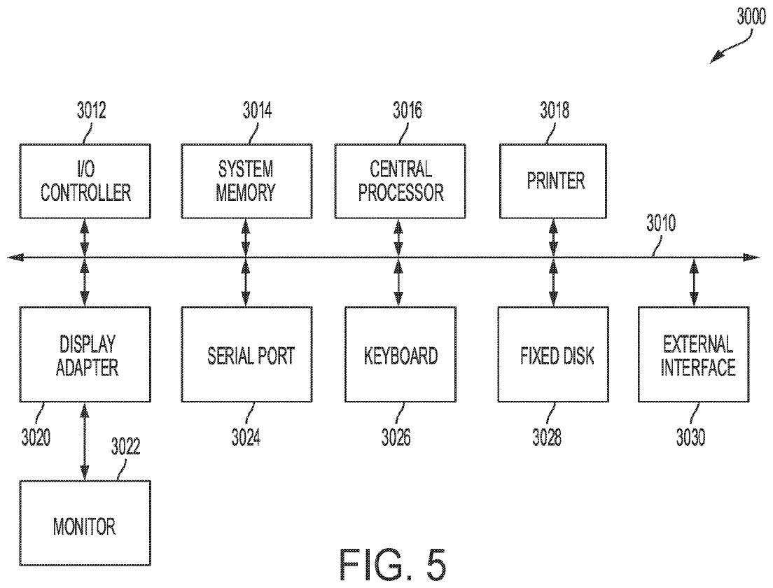

The system and system components described herein with reference to FIGS. 1 and 2 may operate via one or more computer apparatuses to facilitate the functions described herein. Further, the one or more computer apparatuses may use any suitable number of subsystems to facilitate the functions described herein. Examples of such subsystems or components are shown in FIG. 5. The subsystems 1000 shown in FIG. 5 are interconnected via a system bus 1010. Additional subsystems such as a printer 1018, keyboard 1026, fixed disk 1028 (or other memory comprising computer readable media), monitor 1022, which is coupled to display adapter 1020, and others are shown. Peripherals and input/output (I/O) devices, which couple to I/O controller 1012 (which can be a processor or other suitable controller), can be connected to the computer system by any number of means known in the art, such as serial port 1024. For example, serial port 1024 or external interface 1030 can be used to connect the computer apparatus to a wide area network such as the Internet, a mouse input device, or a scanner. The interconnection via system bus 1010 allows the central processor 1016 to communicate with each subsystem and to control the execution of instructions from system memory 1014 or the fixed disk 1028, as well as the exchange of information between subsystems. The system memory 1014 and/or the fixed disk 1028 may embody a computer readable medium.

Referring now to FIG. 6, a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multiprocessor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may include machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment including software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that include a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that include one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the devices, systems, and methods disclosed herein, according to various aspects of the present disclosure, are provided below in the following numbered clauses. An aspect of the devices, systems, and methods may include any one or more than one, and any combination of, the numbered clauses described below.

Clause 1. A computer-implemented method of dispositioning a transaction associated with a payment account, the method including receiving, via an interface system, a registration request for a computing device to host transactions associated with the payment account, generating, via the interface system, a unique identifier for the computing device, correlating, via the interface system, the payment account to the generated unique identifier for the computing device, receiving, via the interface system, a transaction authorization request associated with the payment account, and routing, via the interface system, the received transaction authorization request associated with the payment account to the computing device for dispositioning based on the correlation, wherein the routed transaction authorization request is configured to be dispositioned in accordance with a rule stored locally on the computing device.

Clause 2. The computer-implemented method according to clause 1, further including generating, via the interface system, the payment account in response to receiving the registration request.

Clause 3. The computer-implemented method according to either of clauses 1 or 2, further including confirming, via the interface system, that the payment account has been funded.

Clause 4. The computer-implemented method according to any of clauses 1-3, wherein the rule is predetermined by a user of the computing device via an application accessed by the computing device.

Clause 5. The computer-implemented method according to any of clauses 1-4, wherein dispositioning the transaction authorization request in accordance with the rule includes automatically declining the transaction authorization request.

Clause 6. The computer-implemented method according to any of clauses 1-5, wherein the rule includes a restricted type of transaction made in association with the

Clause 7. The computer-implemented method according to any of clauses 1-6, wherein dispositioning the received transaction authorization request includes determining a type of transaction associated with the transaction authorization request and correlating the type of transaction associated with the transaction authorization request with the restricted type of transaction, and wherein automatically declining the transaction authorization request is based on the correlation.

Clause 8. The computer-implemented method according to any of clauses 1-7, wherein the received transaction authorization request includes a transaction code, and wherein determining the type of transaction associated with the transaction authorization request is based on the transaction code of the transaction authorization request.

Clause 9. The computer-implemented method according to any of clauses 1-8, wherein the rule includes a restricted time of transaction made in association with the payment account.

Clause 10. The computer-implemented method according to any of clauses 1-9, wherein dispositioning the received transaction authorization request includes determining a time of transaction associated with the transaction authorization request, and correlating the time of transaction associated with the transaction authorization request with the restricted time of transaction, wherein automatically declining the transaction authorization request is based on the correlation.

Clause 11. The computer-implemented method according to any of clauses 1-10, wherein correlation includes correlating the information associated with the computing device with information associated with the payment account, wherein the information associated with the payment account includes at least one of a primary account number, a user name, an expiration date, and a card verification value, or combinations thereof.

Clause 12. The computer-implemented method according to any of clauses 1-11, wherein the registration request includes information associated with the computing device, and wherein the information associated with the computing device includes at least one of an IMEI, a phone number, and a MAC address, a SIM, a MIN, a MSIN, or combinations thereof.

Clause 13. An interface system configured to disposition a transaction associated with a payment account, the system including a device registration server communicably coupled to a plurality of computing devices, wherein the device registration server is configured to receive a registration request from a first computing device of the plurality of computing devices, and a routing server communicably coupled to a payment system, wherein the routing server is configured to receive a transaction authorization request from the payment system, and wherein the routing server is further configured to route the transaction authorization request to a first computing device of the plurality of computing devices, wherein the first computing device is configured to disposition the transaction authorization request in accordance with a rule that governs transactions made in association with the payment account, and wherein the rule is stored locally on the first computing device.

Clause 14. The interface system according to clause 13, wherein the registration request includes computing device information and information associated with the payment account.

Clause 15. The interface system according to either of clauses 13 or 14, wherein the device registration server is further configured to register the computing device to host transactions made in association with the payment account based on the computing device information and the information associated with the payment account.

Clause 16. The interface system according to any of clauses 14-15, wherein dispositioning the transaction authorization request in accordance with the rule includes automatically declining the transaction authorization request.

Clause 17. The interface system according to any of clauses 14-16, wherein the rule is predetermined by a user of the first computing device via an application accessed by the first computing device.

Clause 18. A computer-implemented method of dispositioning a transaction associated with a payment account, the method including receiving, via an interface system, a registration request associated with the payment account, wherein the registration request includes information associated with a computing device, registering, via the interface system, the computing device to host transactions made in association with the payment account based on the registration request, receiving, via the interface system, a transaction authorization request associated with the payment account, correlating, via the interface system, the payment account to the information associated with the computing device, and routing, via the interface system, the transaction authorization request to the computing device based on the correlation, wherein the routed transaction authorization request is configured to be dispositioned in accordance with a rule stored locally on the computing device.

Clause 19. The computer-implemented method of claim 18, further including receiving, via the interface system, a signal associated with an approval of the transaction authorization request from the registered computing device, and transmitting, via the interface system, an instruction to transfer an asset associated with the payment account to an acquirer.

Clause 20. The computer-implemented method according to clause 19, further including confirming, via the interface system, that the payment account has been funded.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

All patents, patent applications, publications, or other disclosure material mentioned herein, are hereby incorporated by reference in their entirety as if each individual reference was expressly incorporated by reference respectively. However, none of the patents, patent applications, publications, or other disclosure material mentioned herein are admitted to be prior art. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

What is claimed is:

1. A computer-implemented method of dispositioning a transaction associated with a payment account, the method comprising:
receiving, via an interface system, a registration request for a computing device to host transactions associated with the payment account;
generating, via the interface system, a unique identifier for the computing device;
correlating, via the interface system, the payment account to the generated unique identifier for the computing device;
receiving, via the interface system, a transaction authorization request associated with the payment account; and
routing, via the interface system, the received transaction authorization request associated with the payment account to the computing device for dispositioning based on the correlation, wherein the routed transaction authorization request is configured to be dispositioned in accordance with a rule stored locally on the computing device.

2. The computer-implemented method of claim 1, further comprising generating, via the interface system, the payment account in response to receiving the registration request.

3. The computer-implemented method of claim 1, further comprising confirming, via the interface system, that the payment account has been funded.

4. The computer-implemented method of claim 1, wherein the rule is predetermined by a user of the computing device via an application accessed by the computing device.

5. The computer-implemented method of claim 1, wherein dispositioning the transaction authorization request in accordance with the rule comprises automatically declining the transaction authorization request.

6. The computer-implemented method of claim 5, wherein the rule comprises a restricted type of transaction made in association with the payment account.

7. The computer-implemented method of claim 6, wherein dispositioning the received transaction authorization request comprises determining a type of transaction associated with the transaction authorization request and correlating the type of transaction associated with the transaction authorization request with the restricted type of transaction, and wherein automatically declining the transaction authorization request is based on the correlation.

8. The computer-implemented method of claim 7, wherein the received transaction authorization request comprises a transaction code, and wherein determining the type of transaction associated with the transaction authorization request is based on the transaction code of the transaction authorization request.

9. The computer-implemented method of claim 5, wherein the rule comprises a restricted time of transaction made in association with the payment account.

10. The computer-implemented method of claim 9, wherein dispositioning the received transaction authorization request comprises determining a time of transaction associated with the transaction authorization request, and correlating the time of transaction associated with the transaction authorization request with the restricted time of transaction, wherein automatically declining the transaction authorization request is based on the correlation.

11. The computer-implemented method of claim 10, wherein correlation comprises correlating the information associated with the computing device with information associated with the payment account, wherein the information associated with the payment account comprises at least one of a primary account number, a user name, an expiration date, and a card verification value, or combinations thereof.

12. The computer-implemented method of claim 1, wherein the registration request comprises information associated with the computing device, and wherein the information associated with the computing device comprises at least one of an IMEI, a phone number, and a MAC address, a SIM, a MIN, and a MSIN, or combinations thereof.

13. An interface system configured to disposition a transaction associated with a payment account, the system comprising:
a device registration server communicably coupled to a plurality of computing devices, wherein the device registration server is configured to receive a registration request from a first computing device of the plurality of computing devices; and
a routing server communicably coupled to a payment system, wherein the routing server is configured to receive a transaction authorization request from the payment system, and wherein the routing server is further configured to route the transaction authorization request to a first computing device of the plurality of computing devices, wherein the first computing device is configured to disposition the transaction authorization request in accordance with a rule that governs transactions made in association with the payment account, and wherein the rule is stored locally on the first computing device.

14. The interface system of claim 13, wherein the registration request comprises computing device information and information associated with the payment account.

15. The interface system of claim 14, wherein the device registration server is further configured to register the computing device to host transactions made in association with the payment account based on the computing device information and the information associated with the payment account.

16. The interface system of claim 13, wherein dispositioning the transaction authorization request in accordance with the rule comprises automatically declining the transaction authorization request.

17. The interface system of claim 16, wherein the rule is predetermined by a user of the first computing device via an application accessed by the first computing device.

18. A computer-implemented method of dispositioning a transaction associated with a payment account, the method comprising:
receiving, via an interface system, a registration request associated with the payment account, wherein the registration request comprises information associated with a computing device;
registering, via the interface system, the computing device to host transactions made in association with the payment account based on the registration request;
receiving, via the interface system, a transaction authorization request associated with the payment account;
correlating, via the interface system, the payment account to the information associated with the computing device; and
routing, via the interface system, the transaction authorization request to the computing device based on the correlation, wherein the routed transaction authorization request is configured to be dispositioned in accordance with a rule stored locally on the computing device.

19. The computer-implemented method of claim 18, further comprising:
receiving, via the interface system, a signal associated with an approval of the transaction authorization request from the registered computing device; and
transmitting, via the interface system, an instruction to transfer an asset associated with the payment account to an acquirer.

20. The computer-implemented method of claim 18, further comprising confirming, via the interface system, that the payment account has been funded.
